(19) United States
(12) Patent Application Publication
(10) Pub. No.: US 2020/0074479 A1
(43) Pub. Date: Mar. 5, 2020

(54) METHOD AND SYSTEM FOR DISCOVERING, CHARACTERIZING AND PROJECTING CONSUMPTION BEHAVIORS OF INDIVIDUALS AND GROUPS OF INDIVIDUALS IN FACE-TO-FACE GROUP INTERACTIONS AND ASSIGNING CONSUMER INFLUENCE SCORES TO INDIVIDUALS

(71) Applicant: Lucas Ernesto Wall, Vienna, VA (US)

(72) Inventor: Lucas Ernesto Wall, Vienna, VA (US)

(73) Assignee: Tabletead, Inc., Vienna, VA (US)

(21) Appl. No.: 16/116,261

(22) Filed: Aug. 29, 2018

(51) Int. Cl. G06Q 30/02; H04L 29/08

(52) U.S. Cl. CPC G06Q 30/0201; H04L 67/22; H04L 67/306

(57) ABSTRACT

A method for discovery and generation of behavior profiles of individuals and networks of individuals based on face-to-face group interactions, and assignment of metrics of influence for particular individuals on other individuals within those groups.

### TECHNICAL FIELD

The present disclosure relates to the discovery of face-to-face interactions, and the characterization and projection of behaviors of individuals and networks of individuals using transaction data from group face-to-face consumption, and the assignment of consumer influence scores to individuals.

### BACKGROUND

Retailers, consumer products companies and advertisers face many challenges in attracting consumers to consume their products and services. Pressures on the financial performance of marketing and advertising campaigns, as measured by the return on investment of those campaigns, drive advertisers to seek ways to reduce the cost of advertising and/or to increase consumption resulting from advertising. Consumer intelligence (i.e. the knowledge of consumers' behaviors and preferences) is used to improve targeting of consumers in order to reduce the total number of consumers to whom advertising is targeted, thereby reducing overall advertising costs. Consumer intelligence is also used to create content closely matched with the characteristics of the target audience. This is done to increase consumer response and drive greater consumption. The combination of improved targeting and tailored content for specific consumers allows advertisers to do without ineffective and costly mass marketing. This “personalization” is intended to provide a more precise stimulus for consumers based on their characteristics in order to drive a greater response to marketing campaigns at the lowest possible cost.

Retailers, consumer products and services companies, and advertisers use various sources of data to personalize their marketing campaigns. They use data related to demographics, past consumption, results of surveys, social media, online interactions between individuals and online financial transactions.

Data related to social media and online financial transactions provides a trove of information about online interactions and transactions that can be effectively used to create consumer profiles to use in personalizing marketing campaigns. However, studies show that more than 90% of conversations by consumers about products and services take place offline. In other words, online and social media detect less than 10% of conversations about products and services. Marketers and advertisers currently have a major gap in their ability to get insights about consumers in their offline, face-to-face groups.

Therefore, there is a need for a technical solution that can identify offline, face-to-face interactions, identify the consumption behaviors of individuals in those interactions, project which individual(s) in a given group of individuals is/are likely to influence the consumption of other individuals, and project individual and group consumption behaviors in those face-to-face interactions. Consumer insights based on face-to-face interactions amplify the value of online social network-based consumer intelligence, enabling improved personalization of marketing campaigns.

### SUMMARY

The present disclosure provides a description of methods and systems for identifying individuals' face-to-face interactions, creating attributes for individuals and groups of individuals identified through those interactions, projecting likely individual and group consumption behaviors, and generating consumer influence scores for individuals within those groups.

A method for identifying individuals' face-to-face interactions based on electronic transaction data which may indicate group consumption. A method for using identified face-to-face interactions to identify groups of individuals and relations among individuals in those groups. A method for assigning attributes to individuals and groups of individuals in face-to-face interactions based on transaction history.

A method for projecting behaviors of individuals and groups of individuals based on likelihood of stored individual and group attributes continuing into the future. A method for generating consumer influence scores based on individual and group attributes.

### BRIEF DESCRIPTION OF THE DRAWINGS

The scope of the present disclosure is explained through the following detailed description of exemplary embodiments when read in conjunction with the accompanying drawings. Included in the drawings are the following figures:

FIG. 1 is a block diagram that illustrates a processing server with two databases.

FIG. 2 is a block diagram illustrating high-level system architecture for identifying face-to-face interactions.

FIG. 3 is a block diagram illustrating high-level system architecture for incorporating location data and online and social media data to supplement attributes of individuals and groups of individuals identified through face-to face interactions.

FIG. 4 is a flow diagram illustrating a process of creating and using consumer intelligence, based on face-to-face consumption, in personalization of marketing and advertising campaigns.

FIG. 5 is a flow chart illustrating the process of discovery of face-to-face interactions from electronic transaction data, and the identification of individuals, groups of individuals and relations among individuals participating in face-to-face interactions.

FIG. 6 is a flow chart illustrating the process of assigning attributes to individuals, groups of individuals and relations among individuals identified in face-to-face interactions, the projection of individual and group behaviors and the assignment of consumer influence scores to individuals participating in face-to-face interactions.

FIG. 7 illustrates an exemplary embodiment of a face-to-face network diagram consisting of individuals depicted as nodes, individual relations depicted as links between nodes. Each network, each node and each link with its own specific set of characteristics.

### DETAILED DESCRIPTION

### Glossary of Terms

Consumer influence score—a metric of how influential an individual is within a face-to-face network of individuals.

Face-to-face interaction—an interaction that occurs between individuals, when two or more individuals consume goods and services together as a group in a face-to-face transaction.

Face-to-face transaction—a transaction that occurs when an individual is physically present when a transaction with a merchant takes place. For example, a face-to-face transaction occurs when a consumer consumes at a restaurant or a retail store. A face-to-face transaction does not occur when a consumer buys goods and services online.

Group consumption—takes place when two or more individuals consume goods and services together as a group.

Longitudinal analysis—is a study that involves repeated observations of the same variables over periods of time.

Network—a group of individuals, each individual with at least one face-to-face relation with any other individual in the network.

Relation—is established from one or more face-to-face interactions between any pair of individuals.

Personal identifier—an individual identified with a unique identity in the networks database.

System for Identifying Face-to-face Interactions, Assigning Attributes and Projecting Behaviors of Individuals and Groups of Individuals and Assigning Face-to-face Consumer Influence Scores

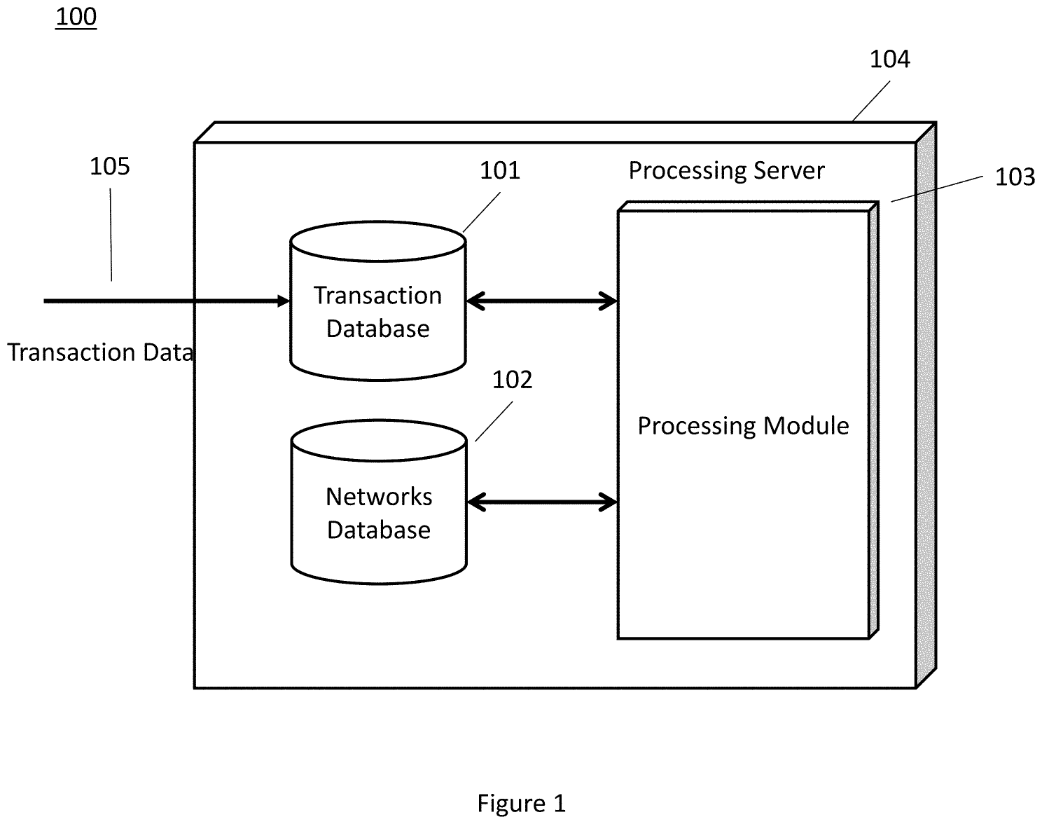

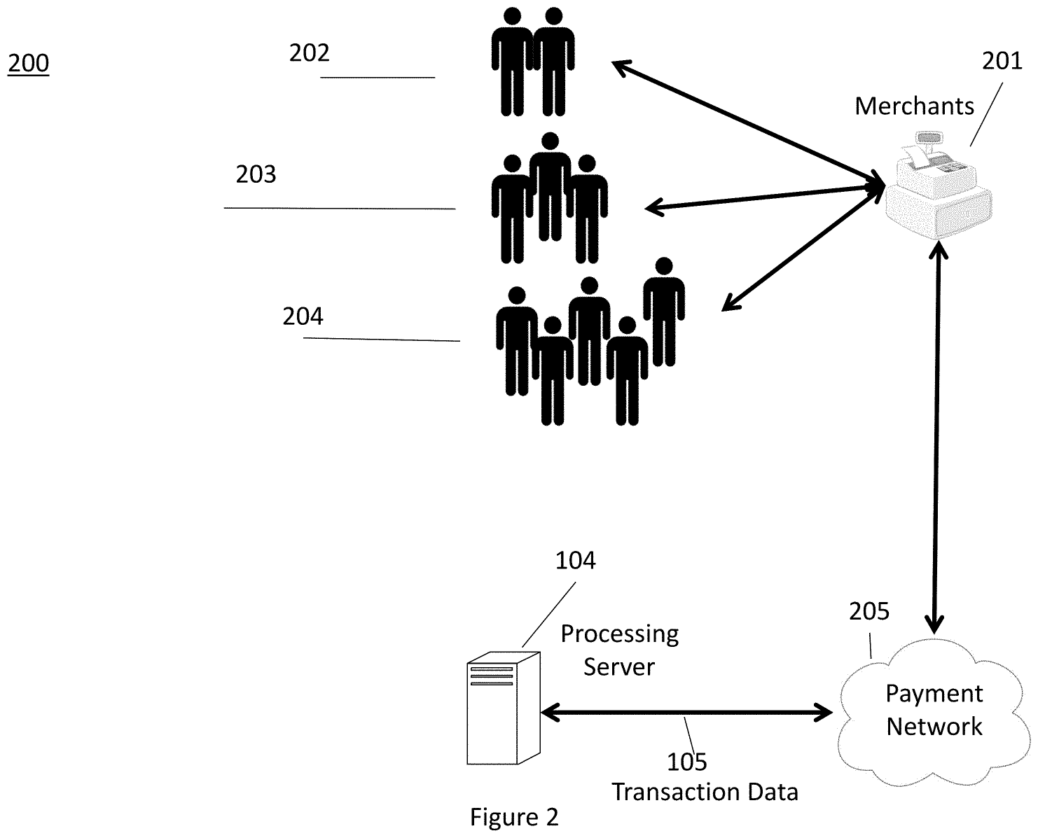

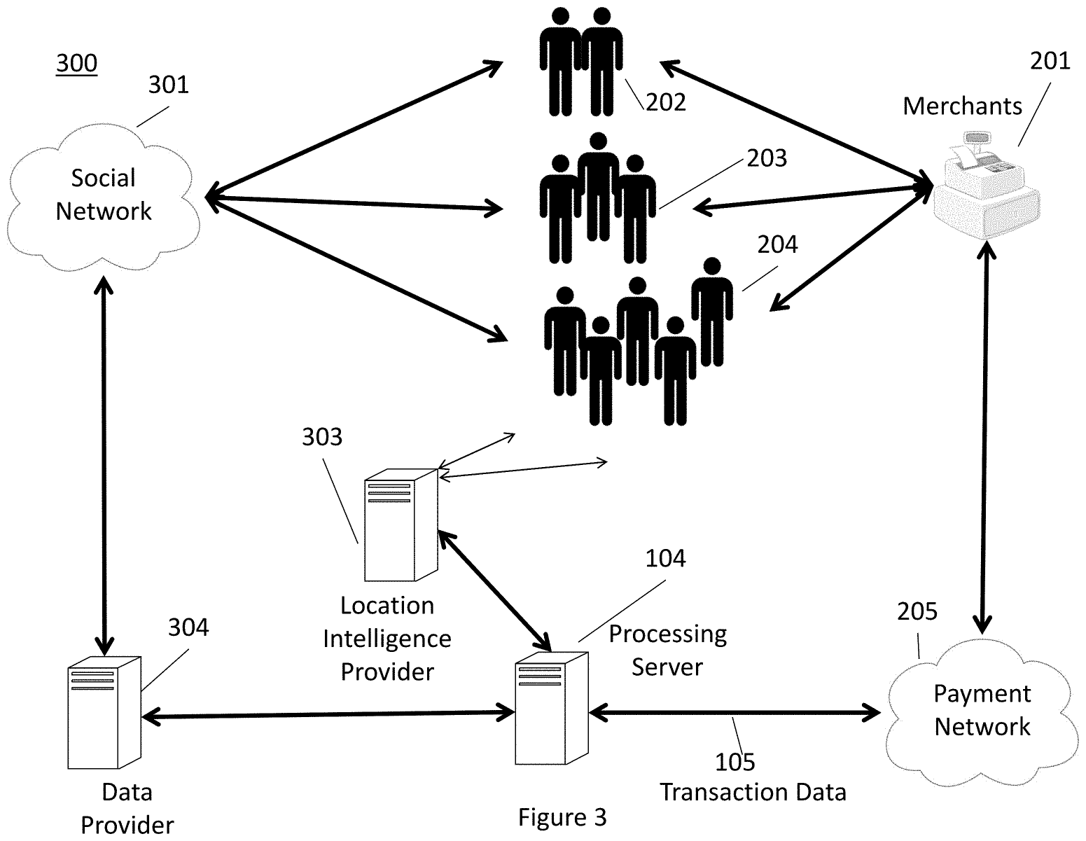

FIG. 1 illustrates a block diagram of a processing server. FIG. 2 illustrates high-level system architecture for identifying individuals' face-to-face interactions based on consumer electronic transaction data. FIG. 3 illustrates high-level system architecture for incorporating location data and online and social media data for assigning individual attributes in group consumption. Reference will now be made to FIG. 1, FIG. 2 and FIG. 3.

As shown in FIG. 2, groups 202, 203 and 204 of two or more individuals conduct transactions with a common merchant 201. The individuals of a given group may have contributed to the payment of a single bill. This could be the case when multiple individuals split the cost of a hotel room, each individual separately running their credit card at the hotel front desk to pay for a portion of the hotel room. One of these groups of two or more individuals could also be identified when each individual of the given group has participated in a face-to-face transaction within a certain physical area or within a certain physical proximity of the face-to-face transactions of the other individuals in that group. This would be the case when two or more individuals share a table at a restaurant but obtaining separate checks, sit contiguously at a theater but participate in independent face-to-face transactions within a vendor at the theatre, or bowl at adjacent lanes in a bowling alley. Further, groups may be determined when two or more individuals have independent face-to-face transactions with a common merchant within a specified period of time. An example of this could be when two or more consumers make payments for food orders at a carry-out restaurant within minutes of each. These exemplary transactions may indicate group consumption where individuals have face-to-face interactions.

The system may include a processing server 104. The processing server may be configured to receive and store electronic transaction data 105 from merchants through a payment network 205 in a transaction database 101. The processing server 104 may be configured to query a transaction database 101 to identify face-to-face interactions.

As shown in FIG. 3, the system may include a Location Intelligence Provider 303. The Location Intelligence Provider 303 may be configured to collect location data of individuals in groups 202, 203 and 204. In an exemplary embodiment, the location data collected by the Location Intelligence Provider 303 may be data that certain individuals in groups 202, 203 and 204 may have given permission to be collected (“opting-in” to the collection of the location data). The Location Intelligence Provider 303 may be configured to electronically transmit data to the processing server 104.

The system may include a Data Provider 304. The Data Provider 304 may be configured to collect online and social media data of individuals in groups 202, 203 and 204. In an exemplary embodiment, the online and social media data collected by the Data Provider 304 may be data that individuals in groups 202, 203 and 204 have given permission to be collected (“opting-in” to the collection of individual data). The Data Provider 304 may be configured to electronically transmit data to the processing server 104.

In some embodiments, the processing server 104 may send requests to Location Intelligence Provider 303 for a specific individual's location data using electronic transmission. Location data may be used by the processing server to supplement transaction data to identify individual and group attributes which are not fully observable through transaction data alone.

In some embodiments, the processing server may send requests to the Data Provider 304 for specific individual's online and social media data using electronic transmission. Online and social media data may be used to supplement transaction data to identify individual and group attributes which are not fully observable through transaction data alone.

In some embodiments, a Data Provider 304 may send requests to the processing server 104 for individual and group attributes based on face-to-face interactions. Individual and group attributes stored in the processing server may be used to supplement online and social network data with individual and group face-to-face attributes which are not observable through online and social network data.

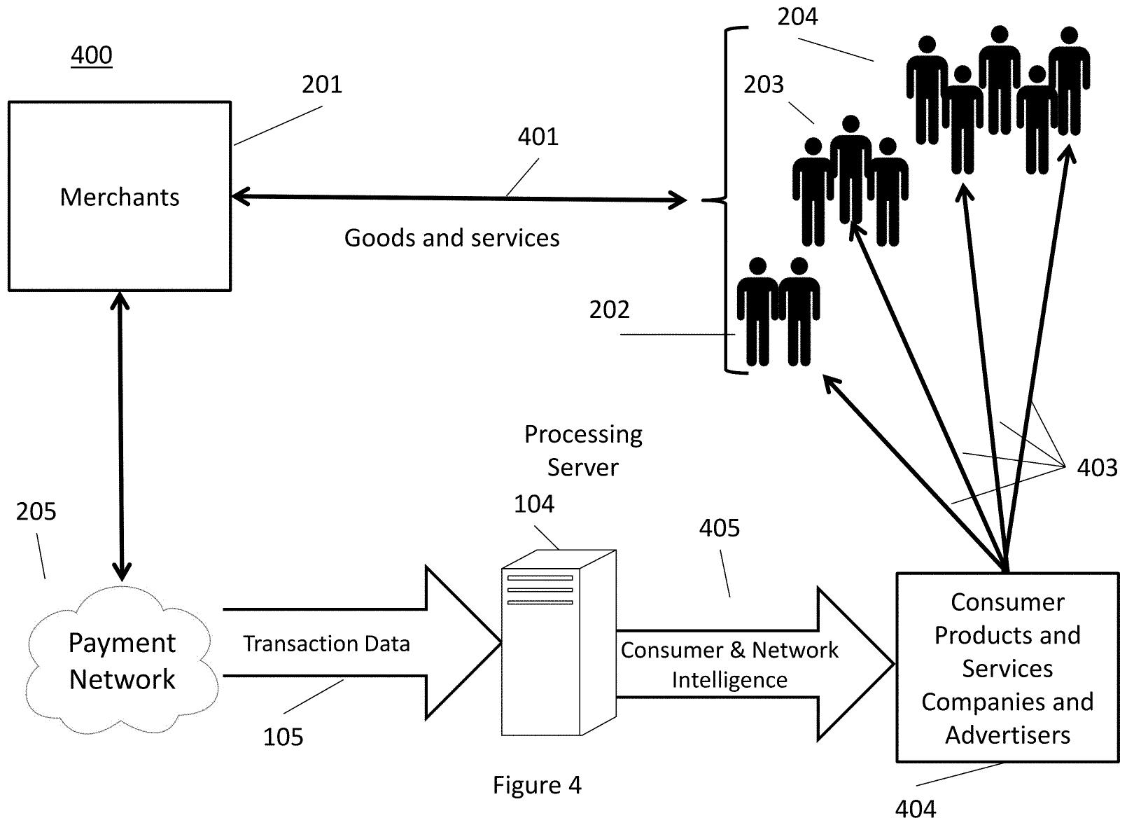

FIG. 4 illustrates the process of creating and using consumer intelligence based on face-to-face interactions in personalization of marketing and advertising campaigns. The system may include groups 202, 203 and 204 of two or more individuals consuming goods and services 301 from a plurality of merchants 201. Transaction data 105 may be transmitted electronically from a payment network 205 to a processing server 104. A processing server 104 may use transaction data to identify face-to-face interactions and generate face-to-face consumer and network intelligence 405 (e.g. identify groups of consumers, identify consumption behaviors of consumers and groups of consumers, project individual and group consumption behaviors, generate consumer influence scores) and may transmit intelligence data to consumer products and services companies and advertisers 404. Consumer products and services companies and advertisers 404 may then use face-to-face consumer and network intelligence 405 to personalize and improve targeting of advertising and marketing campaigns 403 aimed at consumers in groups 202, 203 and 204.

In some embodiments the processing server 104 may execute a query on the transaction database to identify transactions that were conducted after the execution of advertising and marketing campaigns 403 using consumer and network intelligence 405 aimed at consumers in groups 202, 203 and 204, such that the transaction time is within a predetermined period of time and date of the execution of the advertising and marketing campaign, and that involve the product or merchant to which the advertising and marketing campaign is associated. The processing server 104 may use this transaction data to identify consumer response to advertising and marketing campaign and supplement and revise stored individual and group attribute data, and revise and improve stored individual and group behavior projections.

Process for Identifying Face-to-face Interactions, Recording Attributes and Projecting Behaviors of Individuals and Groups of Individuals and Assigning a Face-to-face Consumer Influence Score

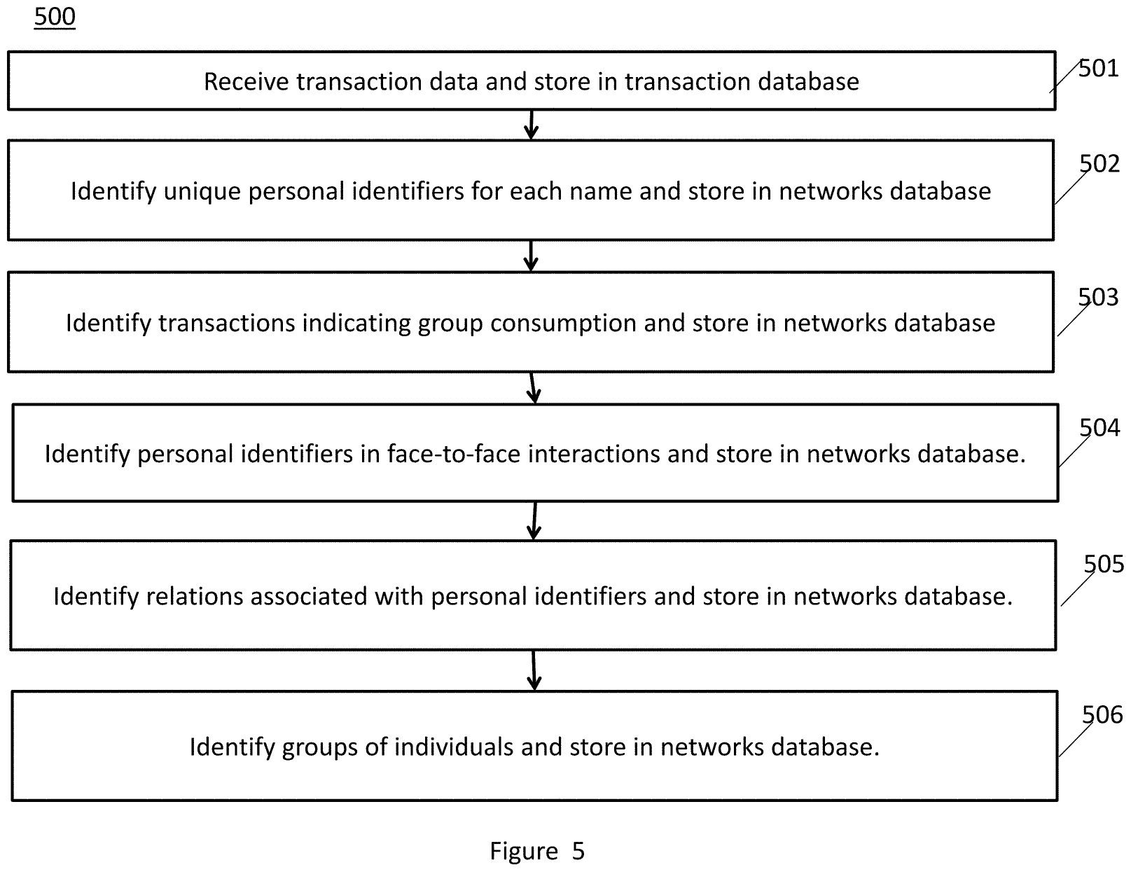

FIG. 5 is a flow chart illustrating the process of discovery of face-to-face interactions from electronic transaction data, and the identification of individuals, groups of individuals and relations among individuals participating in face-to-face interactions.

In step 501, transaction data 105 including data corresponding to one or more face-to-face transactions may be received electronically and stored in a transaction database 101 of a processing server 104, wherein electronic transaction data includes but is not limited to personal identifiers, payment method, transaction identifier, payment amounts, location, date and time, goods and services consumed, number of individuals consuming together, and number of payers. In step 502, the processing server 104 may execute a process on the transaction database to determine that a personal identifier corresponding to a unique personal identity is not processed more than once based on a comparison of multiple 1) similar personal names corresponding to same payment methods and same payer identifier, 2) different payment methods and payer identifiers corresponding to same personal names, and 3) same payer identifier and payment method corresponding to different personal names. The comparison may select personal names with the highest probability of uniqueness when multiple similar or conflicting personal identifiers are identified. The processing server 104 may store the transaction data with corresponding unique personal names and identifiers in a transaction database 101.

In step 503, the processing server 104 may execute a query on the transaction database 101 to identify a subset of transactions indicating group consumption. Transactions associated with more than one personal identifiers or transactions which have one or more common data elements, including date, time, or location may indicate group consumption. The subset may contain transactions where 1) a single bill for goods and services is split by two or more individuals, 2) independent payments of two or more individuals take place at a common merchant within a specified period of time, 3) independent payments of two or more individuals are made within a physical proximity of each other. The identified group transactions may be used to identify face-to-face interactions between individuals. A processing server 104 may store transaction numbers for transactions indicating group consumption in a networks database 102.

In step 504, the processing server 104 may perform a query on the transaction database 101 to identify personal identifiers associated with transaction numbers stored in networks database 102 indicating group consumption. The personal identifiers identified by the query may be stored in the networks database 102.

In one embodiment, the method may further receive location data from a location intelligence provider 303, wherein location data may include individual identifier, location, time and date. The processing server 104 may execute a query on this data to identify data corresponding to personal identifiers in the networks database 102. The processing server may execute a comparison of the location, time and date data associated with personal identifiers to identify instances when the location, time and date data of two or more identifiers is within a specified range of values. The result of the comparison may be used to identify face-to-face interactions. The face-to-face interactions identified by the comparison may be stored in the networks database 102.

In step 505, the processing server 104 may perform a query on the transaction database 101 to identify (face-to-face) transactions associated with each personal identifier corresponding to transactions with each other personal identifier in the networks database. Group consumption between pairs of personal identifiers may indicate relation between those personal identifiers. The subset of transactions may contain transactions where 1) a single bill for goods and services is split by two or more individuals, 2) independent payments of two or more individuals take place at a common merchant within a specified period of time, 3) independent payments of two or more individuals are made within a physical proximity of each other. The processing server may assign a relation value to each distinct pair of personal identifiers. The processing server 104 may store relation values and each associated distinct pair of personal identifiers in the networks database 102.

In step 506, the processing server 104 may execute a query on the networks database 102 to identify groups of personal identifiers with at least one relation with any other personal identifier in the group. The identified groups of personal identifiers may be used to create networks of individuals. The result of the query may be stored in the networks database 102.

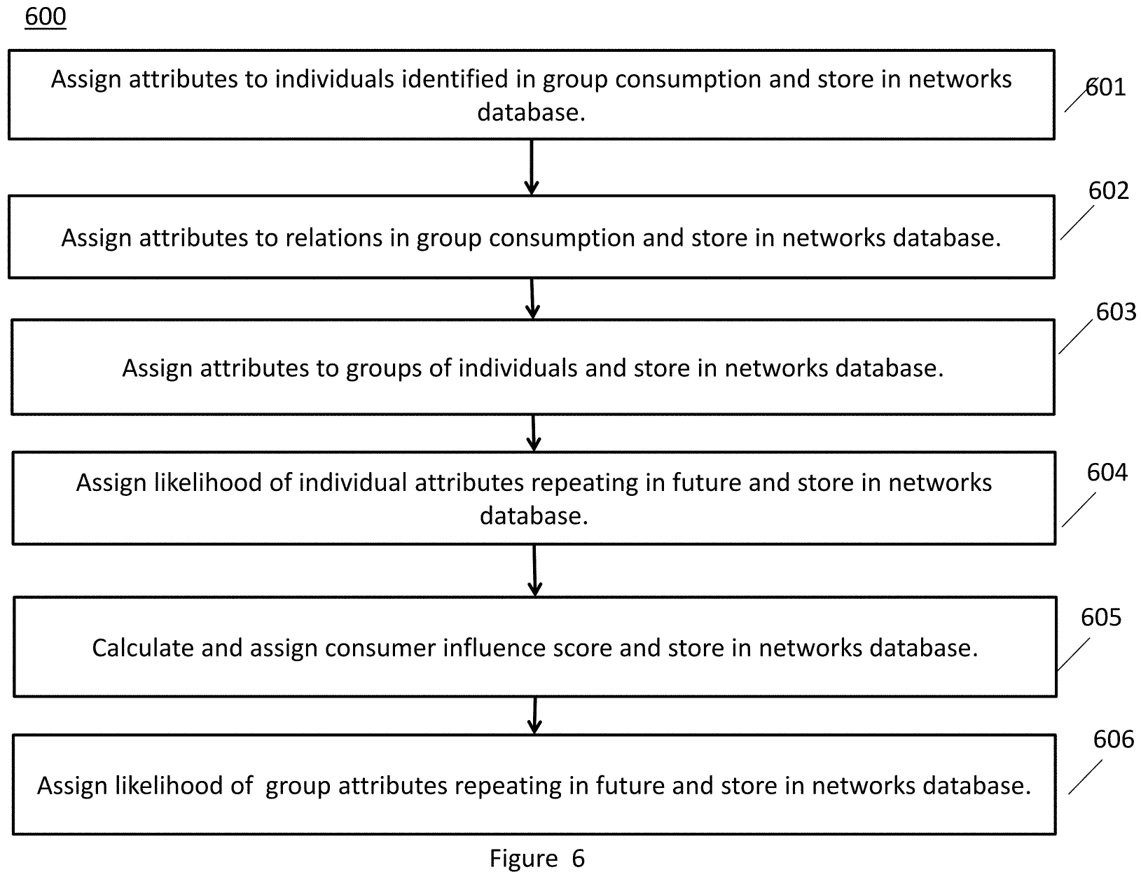

FIG. 6 is a flow chart illustrating the process of assigning attributes to individuals, groups of individuals and relations among individuals identified in face-to-face interactions, the projection of individual and group behaviors and the assignment of consumer influence scores to individuals participating in face-to-face interactions.

In step 601, a processing server 104 may execute a query on the transaction database 101 and the networks database 102 to identify for each personal identifier aggregate information corresponding to the personal identifier transactions, the aggregate information including transaction number, location, date and time of all transactions including face-to-face interactions, number of face-to-face interactions, monetary value of individual and group consumption, history of consumption, and one or more data elements. The processing server 104 may execute a process to calculate and assign values to specified personal identifier attributes based on the aggregate information identified for each personal identifier. The personal identifier attributes may include values for number of relations, frequency of face-to-face interactions, frequency of individual transactions, number of face-to-face interactions in specified period, average number of individuals in group consumption, earliest individual and face-to-face consumption, and one or more attributes. A processing server 104 may then store the values for the attributes of personal identifiers in the networks database 102.

In step 602, a processing server 104 may execute a process on the transaction database and the networks database 102 to identify, for each relation of each personal identifier, aggregate information including transaction number, location, date and time of face-to-face interactions between each pair of individuals, number of face-to-face interactions between pair of individuals, payment by each individual in each group transaction, history of consumption, and one or more data elements. The processing server 104 may execute a process to calculate and assign values to specified relation attributes between pairs of personal identifiers based on the aggregate information identified for each relation. The relation attributes may include values for strength or influence between a personal identifier and another personal identifier, duration of a relation, frequency of relation, number of face-to-face interactions in specified period, earliest individual and face-to-face consumption, and one or more attributes. A processing server 104 may store the values for the attributes of relation between pairs of personal identifiers in the networks database 102.

In step 603, a processing server 104 may execute a query on the transaction database 101 and the networks database 102 to identify for groups of personal identifiers aggregate information including number of personal identifiers in the group, number of relations in the group, strength of relations, transaction number, location, date and time of all transactions, number of face-to-face interactions with each other personal identifier in the database, monetary value of individual and group consumption, history of all consumption, and one or more data elements. The processing server 104 may execute a process to calculate and assign values to specified group attributes based on the aggregate information identified for each group. The group attributes may include values for number of relations, group and individual activity, activity in specified period, consumption in specified period, average number of personal identifiers in group consumption, speed in adding or removing personal identifiers from group, consumption of new products, speed of adoption of tastes, and one or more attributes. A processing server 104 may store the values for the attributes of groups in the networks database 102.

In one embodiment, the method may further receive online and social media data from a data provider 303, wherein online and social media data may include personal identifier, number and personal identifiers of social media network contacts, data associated with sharing of content with network members, date and time of content sharing, date and time of messages. The processing server 104 may execute a query on this data to identify data corresponding to personal identifiers in the networks database 102. The processing server may execute a query on the data from online and social media to further identify attributes of personal identifiers, relations and groups of personal identifiers. The processing server may execute a process to assign value to attributes of personal identifiers, relations and groups of personal identifiers based on online and social media data. The values of attributes may be stored in the networks database 102.

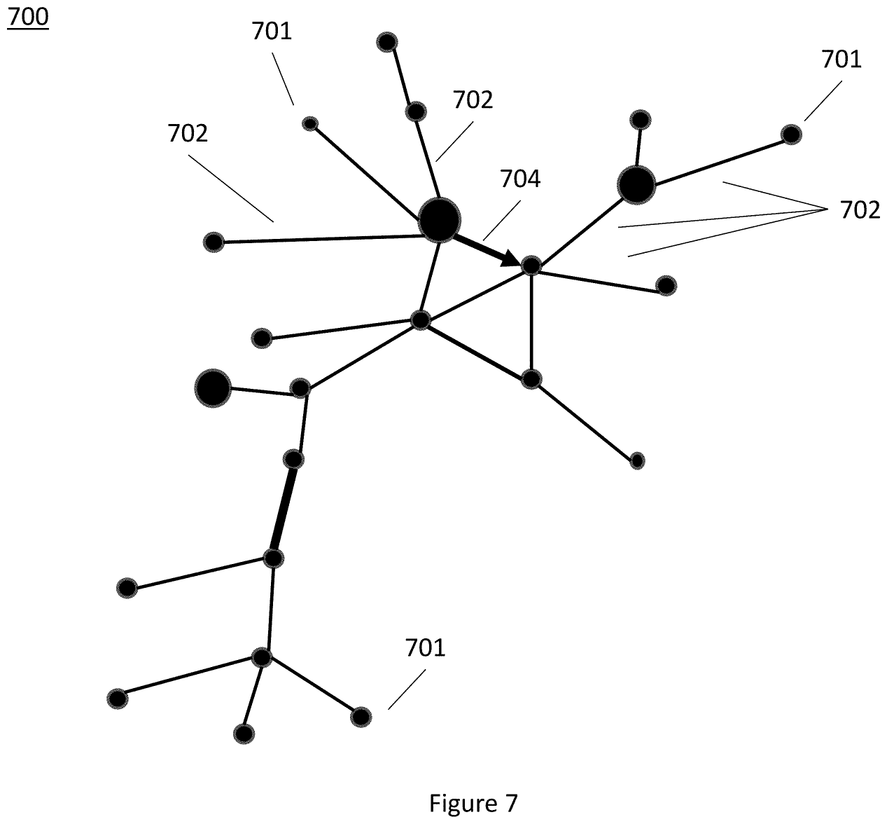

FIG. 7 illustrates an exemplary embodiment of a face-to-face network diagram consisting of individuals depicted as nodes 701, and relations depicted as links 702 between nodes, each relation with its own attributes, where relation strength is depicted by different line thickness.

As shown in FIG. 7, link 704 represents a relation between two personal identifiers corresponding to those nodes to which link 704 connects. As depicted, the arrow on the link indicates that the personal identifier corresponding to the node where the arrow originates has influence over the personal identifier corresponding to the node where the arrow terminates. A metric direction of influence may be determined for any pair of personal identifiers with existing relation in a given network based on a plurality of personal identifiers and group attributes.

In step 604, a processing server 104 may execute a process on the networks database 102 to identify personal identifier attributes, which may repeat in the future. The processing server 104 may execute longitudinal analysis (i.e. observed behavior over time) on the data corresponding to the personal identifier attributes to assign a value to indicate the likelihood (i.e. probability) of the personal identifier attribute repeating in the future. The algorithm for calculating likelihood of a personal identifier attribute repeating in the future may include number of relations, frequency of face-to-face interactions, frequency of individual transactions, number of face-to-face interactions in specified period, average number of personal identifiers in group consumption, earliest appearance of a personal identifier in individual and face-to-face consumption, monetary value of individual consumption, historic consumption, and consumption in specified period of time. The processing server 104 may store values in a networks database 102. It will be understood that a future behavior for which a value of likelihood is assigned can be one of trying new products before anyone else in the group, bringing other personal identifiers into the group, having face-to-face interactions at a specific date in the future, and etc.

In step 605, the processing server 104 may execute a process on the networks database 102 to compare values of attributes of personal identifiers and values of attributes of relations with values corresponding to every other personal identifier in the group to calculate and assign a numerical value of consumer influence (e.g. consumer influence score) for personal identifiers in the networks database 102. The processing server 104 may assign a value to indicate the likelihood that a personal identifier may influence other personal identifiers in the group. The algorithm for calculating values of influence may include value of chronology in consumption (e.g. which personal identifier is associated with a first transaction in time), value of the number of relations, value of attribute relative to adding new relations, value of first (in the group) consumption of new products, value of how recent face-to-face interactions have occurred. The processing server 104 may store consumer influence values for each personal identifier in a networks database 102. It will be understood that a consumer influence score can be a value that indicates the likelihood of a personal identifier influencing other personal identifiers in their group to consume specific products or services, such as when consuming a type of drink, or selecting a credit card, selecting a destination for a vacation or selecting a car to buy.

In step 606, a processing server 104 may execute a process on the networks database 102 to identify group attributes, which may repeat in the future. The processing server 104 may execute longitudinal analysis (i.e. observed behavior over time) on the data corresponding to group attributes to assign a value to indicate the likelihood (i.e. probability) of the group attribute repeating in the future. The algorithm for calculating likelihood of a group attribute repeating in the future may include the number of personal identifiers in the network, number of relations, number of face-to-face interactions in a specified period of time, strength of relations, how often interactions take place, how recently interactions have taken place, monetary value of individual and of group consumption, a monetary value of consumption in a specified period of time, rate of change in the number of personal identifiers in the network, speed of adoption of new products by the network, and one or more data elements. The processing server 104 may store values in a networks database 102. It will be understood that a future behavior can be a group adopting new products before other groups, frequency and speed in adding personal identifiers into the group, adopting new tastes and/or products, speed in spreading new tastes within a group, adopting a specific product or service, having face-to-face interactions within a specified period in the future, and etc.

### Exemplary Embodiments

In an exemplary embodiment, individuals in groups 202, 203 and 204 may consume together within their groups at food and beverage establishments. Electronic transaction data 105 corresponding to consumption using payment cards may be analyzed by a processing server 104, which may indicate group consumption by identifying individuals sharing a merchant's bill or invoice, identifying individuals sharing a table in the establishment, or identifying transactions which may have occurred within a specified time period at the same establishment. The group consumption may indicate face-to-face interactions between and among individuals.

A plurality of transactions may be analyzed to identify repeating instances of individuals' face-to-face interactions. Multiple instances of group consumption may provide transaction data to identify and assign attributes to individuals and groups of individuals, and to assign propensity to individual and groups to behave the same in the future.

Individual and group attributes and attributes expected to repeat in the future may be delivered as consumer and networks intelligence 405 to consumer products and services companies and advertisers 404. Consumer and networks intelligence 405 may be in the form of consumer influence scores or one or more attributes likely to repeat in the future. Consumer and networks intelligence 405 may be used in personalizing marketing campaigns 403 with the goal of improving financial performance of campaigns. Financial performance may be improved through the reduction of marketing and advertising costs by targeting smaller numbers of consumers and/or by increasing sales resulting from marketing and advertising through an improvement in the effectiveness of marketing and advertising. Consumer and networks intelligence 405 may enable marketing campaigns 403 to target only the most influential consumers (e.g. consumers with the highest consumer influence scores) to reduce the cost of advertising. Consumer and networks intelligence 405 may also enable marketing campaigns 403 to tailor content based on consumer attributes to increase the effectiveness of advertising resulting in increased consumption (e.g. using content specifically aligned with a specific propensity to try new products before others). For example, an auto manufacturer may want to know the consumer influence score for each consumer so that it can send advertising material to only high influence consumers for better targeting, and use content specific to face-to-face influencers to achieve greater campaign sales.

In another embodiment, consumer and networks intelligence 405 may be used to personalize marketing campaigns 403. Consumers in groups 202, 203 and 204, which may be targeted with personalized marketing campaigns 403 enabled by consumer and networks intelligence 405, may respond by consuming products and services 401 from merchants 201 within a specified period of time. In turn, that consumption may result in transaction data 105. Transaction data 105 may then be transmitted to a processing server 104. Processing server 104 may measure consumer responses to marketing campaigns 403, and may update or revise values of individual and group attributes stored in the processing server 104 based on the new transaction data 105.

In another embodiment, location data from a location intelligence provider 303 may be received by processing server 104. Location data may be used by processing server 104 to identify individuals in the networks database 102 whose location and time data indicate additional instances of physical proximity. Repeated instances of physical proximity may be used by processing server 104 to add face-to-face interactions to those interactions identified from transaction data, and modify values of personal and group attributes stored in the networks database 102.

In another embodiment, online and social media data, including social network connections, number of followers, sharing of data associated with specific content and one or more data elements may be received by processing server 104 from a data provider 304. Online and social media data may be used by processing server 104 to identify individuals in the networks database 102 whose online and social media data is received. Processing server 104 may execute a process on online and social media data to identify individuals and their relations, and may use this data to supplement and or revise values of individual and group attributes from face-to-face interactions stored in the networks database 102.

What is claimed:

1. A method of discovering face-to-face interactions using electronic data transactions that indicate group consumption, comprising:
receiving by a transaction database of a processing server one or more electronic transaction data sets corresponding to one or more consumer transactions,
wherein the one or more transaction data sets include at least one personal identifier;
storing the one or more transaction data sets in the transaction database;
executing a query by the processing server on the transaction database to determine if the one or more transaction data sets include more than one personal identifier;
wherein, when the one or more transaction data sets include more than one personal identifier, storing the one or more transaction data sets in the networks database.

2. The method of discovering face-to-face interactions using electronic data transactions that indicate group consumption according to claim 1, further comprising:
wherein, when the one or more transaction data sets comprises one transaction data set that includes more than one personal identifier, creating one or more relation values for each distinct pair of personal identifiers in the more than one personal identifier;
assigning the one or more relation values to each distinct pair of personal identifiers;
storing the one or more relation values and each associated distinct pair of personal identifiers in a networks database of the processing server.

3. The method of discovering face-to-face interactions using electronic data transactions that indicate group consumption according to claim 2, further comprising:
executing a query by the processing server on the networks database to identify all relation values and associated distinct pairs of personal identifiers;
creating a network based on all of the all of the relation values and distinct pairs of personal identifiers.

4. The method of discovering face-to-face interactions using electronic data transactions that indicate group consumption according to claim 3, further comprising:
wherein the creating of the network comprises:
executing a query by the processing server on the networks database to identify a first personal identifier,
executing a query by the processing server on the network database to identify all assigned relation values associated with the first personal identifier and any second personal identifiers also associated with the relation values,
creating a network comprising the first personal identifier and the second personal identifiers,
storing the network in the networks database of the processing server.

5. The method of discovering face-to-face interactions using electronic data transactions that indicate group consumption according to claim 1, further comprising:
wherein, when the one or more transaction data sets comprises two or more transaction data sets, and the two or more transaction data sets include a common data set element from among a location, a date and a time, creating one or more relation values for each distinct pair of personal identifiers in the two or more one personal identifiers,
assigning the one or more relation values to each distinct pair of personal identifiers in the two or more personal identifiers;
storing the one or more relation values and each associated distinct pair of personal identifiers in a networks database of the processing server.

6. The method of discovering face-to-face interactions using electronic data transactions that indicate group consumption according to claim 5, further comprising:
executing a query by the processing server on the networks database to identify all relation values and associated distinct pairs of personal identifiers;
creating a network based on all of the all of the relation values and distinct pairs of personal identifiers.

7. The method of discovering face-to-face interactions using electronic data transactions that indicate group consumption according to claim 6, further comprising:
wherein the creating of the network comprises:
executing a query by the processing server on the networks database to identify a first personal identifier,
executing a query by the processing server on the network database to identify all assigned relation values associated with the first personal identifier and any second personal identifiers also associated with the relation values,

8. A method for assigning attributes to individuals identified in group consumption, comprising:
executing a query by a processing server on a transaction database to identify a plurality of transaction data sets corresponding to a plurality of consumer transactions in the transaction database,
wherein each transaction data set of the plurality of transaction data sets includes a common personal identifier;
storing the plurality of transaction data sets in the networks database.

9. The method for assigning attributes to individuals identified in group consumption according to claim 8,
wherein each of the transaction data sets of the plurality of transaction data sets includes at least one of a payment amount, a location, a date, a time, a good or service consumed, a number of payers and a transaction number.

10. The method for assigning attributes to individuals identified in group consumption according to claim 8, further comprising:
using the plurality of transaction data sets to determine an aggregate information corresponding to the personal identifier.

11. The method for assigning attributes to individuals identified in group consumption according to claim 10, further comprising:
wherein the aggregate information includes at least one of a number of consumer transactions associated with the personal identifier, a frequency of consumer transactions associated with the personal identifier, a most recent consumer transaction associated with the personal identifier, and a total monetary value of consumer transactions associated with the personal identifier;
assigning attribute values to the personal identifier based on the aggregate information;
storing the attribute values in the networks database.

12. A method for projecting behaviors of individuals identified in group consumption, comprising:
executing a query by a processing server on a networks database to identify one or more personal identifiers, each personal identifier having associated with it at least one individual attribute value,
executing an analysis by the processing server on each of the one or more personal identifiers and its associated at least one individual attribute to determine a likelihood of an occurrence of a future behavior and calculating the value of one or more likelihood attributes based on the analysis;
assigning the value of the one or more likelihood attributes to the one or more personal identifiers;
storing the value of the one or more likelihood attributes corresponding to the one or more personal identifiers in the networks database.

13. The method for projecting behaviors of individuals identified in group consumption according to claim 12, further comprising:
executing a query by a processing server on a networks database to identify a plurality of personal identifiers;
analyzing the values of likelihood attributes and individual attributes corresponding to each personal identifier in the plurality of personal identifiers;
calculating one or more personal influence scores corresponding to each of the personal identifiers in the plurality of personal identifiers;
assigning one or more personal influence scores to each personal identifier in the plurality of personal identifiers;
storing the values of the one or more personal influence scores in the networks database of the processing server.

14. The method for projecting behaviors of individuals identified in group consumption according to claim 13,
wherein the analyzing comprises comparing the values of likelihood attributes and individual attributes corresponding to each personal identifier in the plurality of personal identifiers to the values of likelihood attributes and individual attributes corresponding to each other personal identifier in the plurality of personal identifiers.

15. The method for projecting behaviors of individuals identified in group consumption according to claim 14, further comprising:
executing a query by a processing server on a networks database to identify a plurality of personal identifiers;
calculating one or more group attributes corresponding to the plurality of personal identifiers based on the likelihood attributes and the individual attributes of the personal identifiers in the plurality of personal identifiers;
storing the group attribute in the networks database.

16. The method for projecting behaviors of individuals identified in group consumption according to claim 15, further comprising:
using the one or more group attributes to project a behavior of a personal identifier or a plurality of personal identifiers.

17. The method for projecting behaviors of individuals identified in group consumption according to claim 12,
wherein the analysis is a longitudinal analysis.

18. The method for projecting behaviors of individuals identified in group consumption according to claim 12,
wherein the at least one individual attribute is based on at least one of a number of consumer transactions associated with the personal identifier, a frequency of consumer transactions associated with the personal identifier, a most recent consumer transaction associated with the personal identifier, and a total monetary value of consumer transactions associated with the personal identifier.
